(19) United States
(12) Patent Application Publication
(10) Pub. No.: US 2009/0161801 A1
(43) Pub. Date: Jun. 25, 2009

(54) RECEIVER WITH DISCRETE-TIME FILTERING AND DOWN-CONVERSION

(75) Inventors: Ming-Feng Huang, Hsinchu County (TW); Ming-Hau Tseng, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/025,779

(22) Filed: Feb. 5, 2008

(30) Foreign Application Priority Data
Dec. 24, 2007 (TW) 96149682

(51) Int. Cl. H04L 27/06

(52) U.S. Cl. 375/344

(57) ABSTRACT

A receiver with discrete-time filtering and down-conversion is provided. The receiver includes a mixer and a sampling-and-filtering device. The sampling-and-filtering device is coupled to the mixer. The mixer receives a first radio frequency signal, and then mixes the first radio frequency with a reference signal to generate a first signal. The first signal is a continuous-time signal. The sampling-and-filtering device sequentially samples, filters, and down-converts the first signal according to a clock signal to generate a second signal.

### CROSS-REFERENCE TO RELATED APPLICATION

This application claims the priority benefit of Taiwan application serial no. 96149682, filed on Dec. 24, 2007. The entirety of the above-mentioned patent application is hereby incorporated by reference herein and made a part of this specification.

### BACKGROUND OF THE INVENTION

1. Field of the Invention

The present invention generally relates to a receiver, in particular, to a receiver with discrete-time filtering and down-conversion.

2. Description of Related Art

With the progress of wireless technology, the architectures of wireless communication receivers are increasingly tending towards the ends of light weight, small size and power saving. Generally speaking, the front-end circuit of the receiver needs high linearity, so as to improve the correctness of the received signal demodulated and decoded by the receiver.

The progress of processing technology enables manufactures to produce high speed and small-sized wireless communication receivers. However, the supply voltage may drop, and this may cause the linearly decreasing of an active circuit (e.g. an active amplifier). On the other hand, although the progress of processing technology results in the decreasing of area of the wireless communication receivers, the ratio of the capacitors to the total area of the wireless communication receiver is hard to reduce, but increase instead. Therefore, in order to solve the problems, many manufactures merge the mixer, filter, and sampler of the wireless communication receivers on one circuit.

U.S. Pat. Nos. 6,963,732 B2 and 7,079,826 B2, granted to Texas Precision Instruments Company, America in 2005, 2006, mainly use a switched-capacitor network to perform sampling, filtering and down-conversion, thus obtaining a good linearity and saving the chip area. However, receivers disclosed in the two patents can only achieve the filtering effect on narrowband signals, and the folding noises generated during sampling and down-conversion will lead to the decrease of the performance of the entire system.

FIG. 1 is a system block diagram of a receiver 10 set forth by Texas Precision Instruments. Referring to FIG. 1, the receiver 10 includes a low noise transconductance amplifier 11, a local oscillator 12, a digital control unit 13, a switched-capacitor network 14, an intermediate frequency (IF) amplifier 15, an analog signal processor 16, and an analog-to-digital converter (ADC) 17. The coupling relationships of the elements are as shown in FIG. 1 and will not be described herein again.

The low noise transconductance amplifier 11 receives a radio frequency signal RF_sig from a wireless channel and converts the received radio frequency signal RF_sig from a voltage signal into a corresponding current signal, and amplifies the current signal. The local oscillator 12 generates an oscillation signal having a similar frequency of the radio frequency signal RF_sig for the digital control unit 13. The digital control unit 13 generates a plurality of different clock control signals according to the oscillation signal for the switched-capacitor network 14, so as to control the charge or discharge of each capacitor in the switched-capacitor network 14. The switched-capacitor network 14 charges or discharges the capacitors thereof according to the clock control signals with particular phase, so as to perform sampling, filtering, and down-conversion in turn. The IF amplifier 15 amplifies the output of the switched-capacitor network 14 at the IF band, and sends the amplified signal to the analog signal processing unit 16. The analog signal processing unit 16 performs an analog signal processing on its received signal, and then sends the processed signal to the ADC 17. Finally, the ADC 17 converts its received analog signal into a digital signal, in which the digital signal is a baseband signal BB_sig.

FIG. 2 is a circuit diagram of the switched-capacitor network 14 of the receiver 10. Referring to FIG. 2, the switched-capacitor network 14 includes a plurality of capacitors C, two load capacitors C_{A}, and a plurality of transistors. The control signals S1˜S8, R1˜R8, and SH1˜SH8 are generated by the digital control unit 13 according to the oscillation signal output by the local oscillator 12. When the control signals SH1˜SH8 turn on the transistors, the capacitors C are discharged through the transistors. The switched-capacitor network 14 performs sampling, filtering, and down-conversion by the circuit in FIG. 2.

The receiver 10 adopts the architecture of the switched-capacitor network 14, such that the switched-capacitor network 14 is used to perform sampling, filtering, and down-conversion. However, the switched-capacitor network 14 may generate a first order infinite impulse response (first order IIR) at the load capacitor C_{A}, and thus the receiver 10 can only be used to filter and receive the narrowband signal; moreover, the folding noises generated during sampling and down-conversion may decrease the performance of the entire receiver 10. Further, the higher frequency of the oscillation signal leads to the larger power consumptions of the local oscillator 12 and digital control unit 13. Since the frequency of the oscillation signal of the local oscillator 12 is approximate to the frequency of the radio frequency signal RF_sig, the problem of larger power consumption of the receiver 10 is incurred.

Further, Jakonis et al. set forth another receiver structure in June, 2005 (see, Darius Jakonis, Kalle Folkesson, Jerzy Dabrowski, and Christer Svenssson, “A 2.4 GHz RF Sampling Receiver Front End in 0.18 um CMOS”, IEEE Journal of Solid-State Circuits, Vol. 40, No. 6, June, 2005). The receiver disclosed in this paper basically down-converts the received frequency to around ¼ of the sampling frequency, so as to generate an IF signal, and then down-converts the frequency of the IF signal to the baseband frequency. The principle is to use a sampling-and-holding mixer (S/H mixer) and a filtering-and-down-conversion device to achieve the purpose of sampling, filtering, and down-conversion.

FIG. 3 is a system block diagram of a receiver 20 set forth by Jakonis et al. Referring to FIG. 3, the receiver 20 includes an antenna 28, a radio frequency filter 21, a low noise amplifier (LNA) 22, an S/H mixer 23, filtering-and-down-conversion devices 24I, 24Q, a clock circuit 25, a local oscillator 26, and ADCs 27I, 27Q. The coupling relationships of the elements are illustrated in FIG. 3 and will not be described herein again.

The antenna 28 receives a radio frequency signal from the wireless channel and sends the radio frequency signal to the radio frequency filter 21 for filtering. Next, the LNA 22 amplifies the output signal of the radio frequency filter 21 and sends the amplified output signal to the S/H mixer 23. The local oscillator 26 generates an oscillation signal to the clock circuit 25 so as to generate a plurality of reference signals and a sampling signal. The ratio of the frequency of the sampling signal to the frequency of the radio frequency signals is 4:9. The S/H mixer 23 samples the radio frequency signal, and mixes the sample value with the sampling signal to generate an IF signal. The IF signal is the discrete-time signal, and the frequency of the IF signal is ¼ of the frequency of the sampling signal. Then, the IF signal enters the filtering-and-down-conversion devices 24I, 24Q respectively, and the filtering-and-down-conversion devices 24I, 24Q filter and down-convert the IF signal according to a plurality of reference signals respectively, so as to generate baseband signals of the channel I and the channel Q. Finally, ADCs 27I, 27Q convert the baseband signals of the channel I and channel Q into the digital baseband signals of the channel I and channel Q.

FIG. 4 is a schematic frequency spectrum diagram of the receiver 20 in various frequency operation regions. Referring to FIGS. 3 and 4 together, in the RF segment, i.e., when the radio frequency signal has not been mixed, the frequency of the radio frequency signal is f_{c}, where fₛ is the sampling frequency, fᵢₘ is the image frequency, f_{IF} is the intermediate frequency, and BW_{RF} is the bandwidth of the radio frequency signal. In the IF segment, i.e., when the IF signal has not been filtered and down-converted, the frequency of the IF signal is fₛ/4, where f_{ADC} is the sampling frequency of the ADC. Finally, in the BB segment, i.e., after the IF signal is filtered and down-converted, the frequency of the baseband signal is 0, where BW_{ch} is the bandwidth of the baseband signal, and BW_{IF} is the bandwidth of the IF signal.

Further, the generation of the folding noises during sampling may also be illustrated with reference to FIG. 4. When the radio frequency signal is sampled in the RF segment, a plurality of image frequencies would be noises. Next, after down-conversion, noises at the plurality of image frequencies may be folded into the IF segment. Finally, after sampling and down-conversion to the BB segment, since over many noises at image frequencies are folded into the baseband signal, the correctness of the baseband signal is influenced, and thus the performance of the entire system is decreased.

FIG. 5 is a diagram showing sub-circuits of the filtering-and-down-conversion devices 24I, 24Q. The filtering-and-down-conversion devices 24I, 24Q are constituted by a plurality of identical sub-circuits and work in conjunction with different clock signals. As shown in FIG. 5, the sub-circuits of the filtering-and-down-conversion devices 24I, 24Q include a plurality of transistors, a plurality of capacitors Cₙ₁˜Cₙ₆, Cₚ₁˜Cₚ₅, C_{Dn}, and C_{Dp}. The plurality of reference signals clk₁˜clk₂₄ and clk_{D1}˜clk_{D4} generated by the clock circuit 25 controls the ON or OFF of the plurality of corresponding transistors in FIG. 5, thereby charging and integrating charges of the capacitors Cₙ₁˜Cₙ₆, Cₚ₁˜Cₚ₅, C_{Dn}, and C_{Dp}. By controlling charging and integrating charges of the capacitors Cₙ₁˜Cₙ₆, Cₚ₁˜Cₚ₅, C_{Dn}, and C_{Dp}, the result of the signal OUTₚ minus the signal OUTₙ is the baseband signal generated after the IF signal is filtered and down-converted.

The receiver 20 mainly down-converts the frequency to around ¼ of the sampling frequency to generate an IF signal, and then down-converts the frequency of the IF signal to the baseband frequency. However, since the plurality of capacitors in the filtering-and-down-conversion devices 24I, 24Q is not provided with discharging mechanisms, the operation of IIR is triggered as a whole, thus narrowing the entire bandwidth, which is not applicable to transmission of broadband. Furthermore, since the receiver 20 uses the S/H mixer 23, folding noises are formed at integer multiples of the sampling frequency, thus affecting the performance of the entire receiver 20.

Referring to FIG. 6, the system block diagram of the receivers set forth by Jakonis et al. and Texas Precision Instruments Company may be simplified into the diagram of FIG. 6. As shown in FIG. 6, the conventional receiver 30 with discrete-time filtering and down-conversion includes a sampling-and-down-conversion device 31, a filtering-and-down-conversion device 32, and an ADC 33. The filtering-and-down-conversion device 32 is coupled to the sampling-and-down-conversion device 31, and the ADC 33 is coupled to the filtering-and-down-conversion device 32. The filtering-and-down-conversion device 32 includes a charge-domain filter for filtering and down-converting the discrete-time signal DT1 to generate a discrete-time signal DT2. The charge-domain filter refers to the filter formed based on the principle of controlling the transistors to charge and discharge the capacitors, as stated above. The sampling-and-down-conversion device 31 samples and down-converts the radio frequency signal RF_sig according to the sample clock signal CLKₛ to generate the discrete-time signal DT1. The ADC 33 converts the discrete-time signal DT2 into the digital signal BB_sig. The digital signal BB_sig is the baseband signal, fₛ is the sampling frequency, and CLK_{REF} is the clock signal of the filtering-and-down-conversion device 32. The filtering-and-down-conversion device 32 generates a plurality of the reference signals according to the clock signal CLK_{REF} to control the ON or OFF of the transistors, thus achieving the purpose of charging and discharging the capacitors.

Next, referring to FIGS. 7 and 8, FIG. 7 is a power-frequency spectrum graph of the discrete-time signal DT1 in FIG. 6, and FIG. 8 is a power-frequency correspondence table of the discrete-time signal DT1 in FIG. 7. As shown in FIGS. 7 and 8, the discrete-time signal DT1 generated at the frequency position of the conventional receiver 30 causes the filtering-and-down-conversion device 32 to generate folding signals at the same frequency to DT2 severely (i.e. a plurality of the folding noises are folded into the signal DT2). Similarly, radio frequency signal RF_sig passing through the sampling-and-down-conversion device 31 will also have the same problem of folding noises in DT1 (i.e. a plurality of folding noises are folded into the signal DT1). The frequency of the input radio frequency signal RF_sig is 2414 MHz, the sampling frequency fₛ is 1072 MHz, the discrete-time signal DT1 is the IF signal, and the center frequency is 270 MHz. However, a plurality of signals at integer multiples of the sampling frequency nfₛ and the corresponding frequency nfₛ±270 MHz can be found in the spectrum of the discrete-time signal DT1. The signals are folded into the DT2 by the filtering-and-down-conversion device 32, thus decreasing the performance of the receiver 30.

The conventional receivers 10, 20, 30 down-converts the signals and samples the signals simultaneously, thus they causes the problems of the folding noises. If the folding noises are too large, the performance of the entire receiver is decreased.

### SUMMARY OF THE INVENTION

Accordingly, the present invention is directed to a receiver with discrete-time filtering and down-conversion, which can moderate the influence of the folding noises on the performance of the receiver, and have reduced power consumption due to the decrease of the sampling frequency.

The present invention provides a method of discrete-time filtering and down-conversion. The receiver adopting the method can moderate the influence of the folding noises on the performance of the receiver, and have reduced power consumption due to the decrease of the sampling frequency.

The present invention provides a receiver with discrete-time filtering and down-conversion. The receiver includes a mixer and a sampling-and-filtering device. The sampling-and-filtering device is coupled to the mixer. The mixer receives a first radio frequency signal and mixes a reference signal with the first radio frequency signal to generate a first signal. The first signal is a continuous-time signal. The sampling-and-filtering device samples, filters, and down-converts the first signal according to the clock signal to generate a second signal.

The present invention provides a method of discrete-time filtering and down-conversion. First, a first radio frequency signal is received and mixed with a reference signal to generate a first signal. The first signal is a continuous-time signal. Next, the sampling-and-filtering device samples, filters, and down-converts the first signal according to the clock signal to generate a second signal.

The present invention adopting the mixer directly mixes and down-converts the radio frequency signal, and then samples, filters, and down-converts the generated first signal, thus significantly attenuating the power of the folding noises at certain frequencies, and achieving a better performance than conventional receivers. Furthermore, a frequency fₛ of the reference signal for mixing and a frequency f_{c} of the first radio frequency signal are in a relationship of fₛ=(f_{c}±f_{IF})/n. When n is increased, the power consumed by the receiver is reduced.

In order to make the features and advantages of the present invention more clear and understandable, the following embodiments are illustrated in detail with reference to the appended drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block diagram of a receiver 10 set forth by Texas Precision Instruments.

FIG. 2 is a circuit diagram of a switched-capacitor network 14 in the receiver 10.

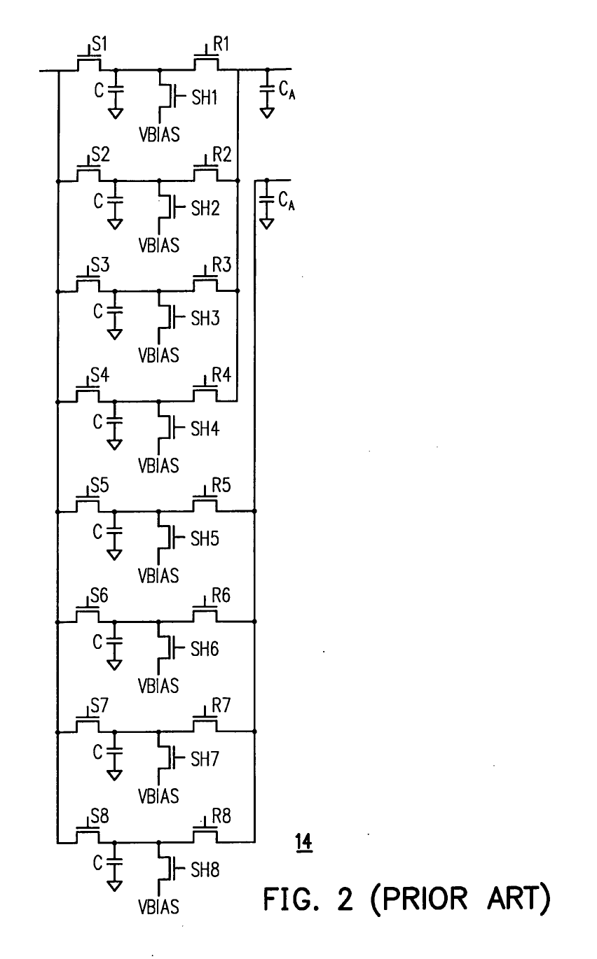

FIG. 3 is a system block diagram of a receiver 20 set forth by Jakonis et al.

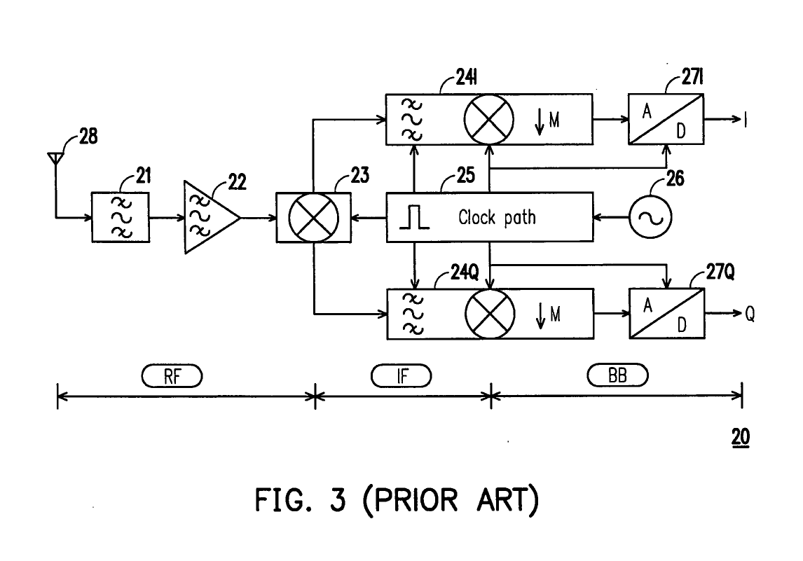

FIG. 4 is a schematic frequency spectrum diagram of the receiver 20 in various frequency operation regions.

FIG. 5 is a diagram showing sub-circuits of the filtering-and-down-conversion devices 24I, 24Q.

FIG. 6 is a system block diagram of conventional receivers with discrete-time down-conversion function.

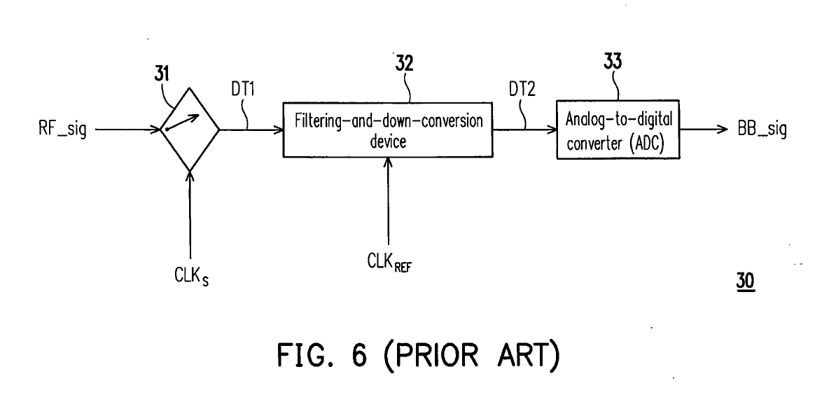

FIG. 7 is a power-frequency spectrum graph of a discrete-time signal DT1 in FIG. 6.

FIG. 8 is a power-frequency correspondence table of the discrete-time signal DT1 in 7.

FIG. 9A is a system block diagram of a receiver 40 according to an embodiment of the present invention.

FIG. 9B is a system block diagram of a receiver 50 according to another embodiment of the present invention.

FIG. 9C is a schematic frequency spectrum diagram of the receiver 50 in various frequency operation regions.

FIG. 10 is a flow chart of a method of discrete-time filtering and down-conversion according to an embodiment of the present invention.

FIG. 11 is a power-frequency spectrum graph of the first signal CT in FIG. 9A.

FIG. 12 is a power-frequency correspondence table of the first signal CT in FIG. 11.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

In order to solve the problems of the interference and influence of the folding noises generated by a conventional receiver during signal down-conversion, a receiver with discrete-time filtering and down-conversion is provided in an embodiment of the present invention. Different from conventional receiver, the signal generated by the receiver after down-converting the radio frequency signal does not have the severe problem of folding noises. In other words, the receiver in the embodiment of the present invention can reduce the power of the folding noises at certain frequencies, thus having a better performance than the conventional receiver.

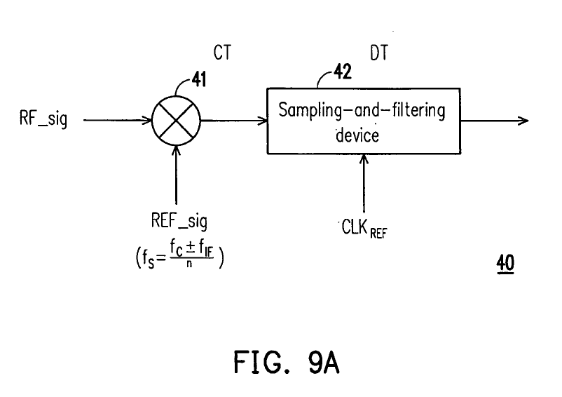

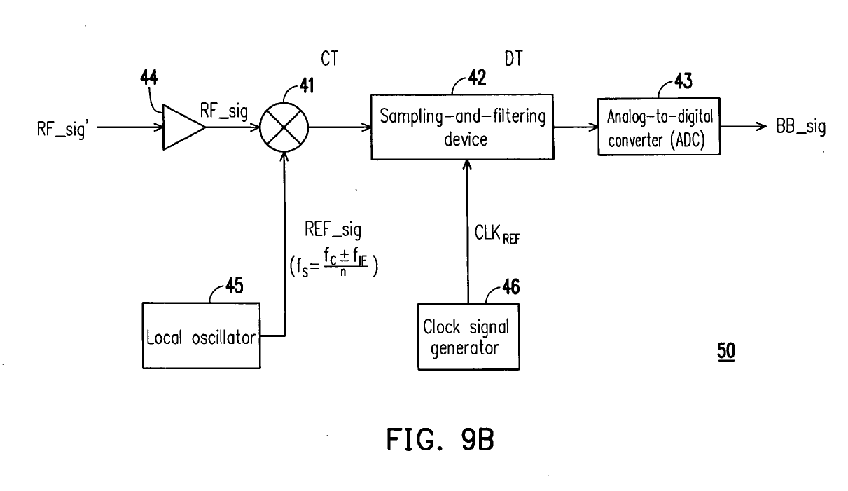

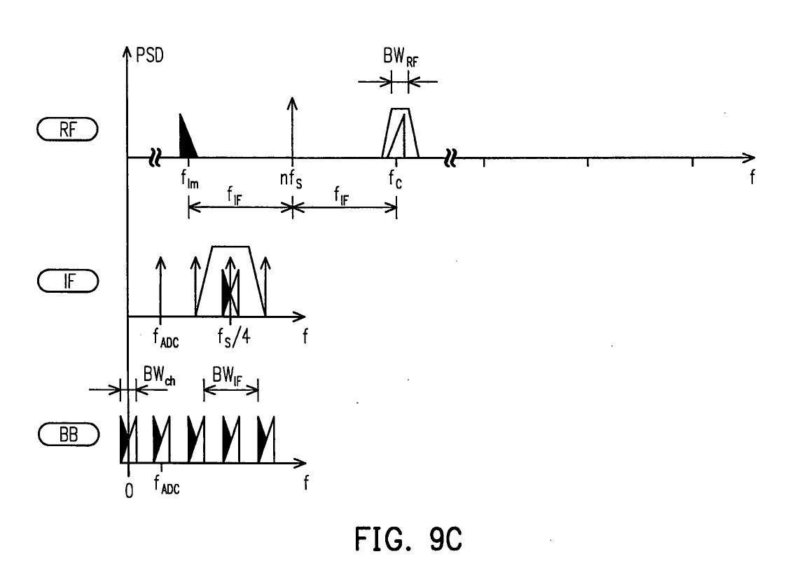

FIG. 9A is a system block diagram of a receiver 40 according to an embodiment of the present invention. Referring to FIG. 9A, the receiver 40 includes a mixer 41 and a sampling-and-filtering device 42. The sampling-and-filtering device 42 is coupled to the mixer 41. The mixer 41 receives the radio frequency signal RF_sig and mixes a reference signal REF_sig with the radio frequency signal RF_sig to generate a first signal CT (having a frequency of f_{IF}). The first signal CT is a continuous-time signal. The sampling-and-filtering device 42 samples, filters, and down-converts the first signal CT according to a clock signal CLK_{REF} to generate a second signal DT.

The frequency fₛ of the reference signal and the frequency f_{c} of the radio frequency signal RF_sig are in a relationship of fₛ=(f_{c}±f_{IF})/n, where n is a positive integer. When the frequency of the reference signal of the receiver 40 is decreased, the power consumed by the entire receiver 40 is reduced. As long as n is increased (that is, the frequency fₛ of the reference signal is decreased), the power consumed by the receiver 40 is reduced accordingly.

Generally speaking, the first signal CT is the IF signal, and the second signal DT is the baseband signal. However, if the required frequency f_{IF} of the first signal CT is very low, both the first signal CT and the second signal DT are the baseband signals. In other words, the receiver 40 of the above embodiment is not required to down-convert the frequency signal RF_sig into the IF signal, and then down-convert the IF signal into the baseband signal. In some applications, the receiver can directly down-convert the radio frequency signal RF_sig into the baseband signal, and then the sampling-and-filtering device 42 processes the signal to obtain a desired baseband signal.

FIG. 9B is a system block diagram of a receiver 50 according to another embodiment of the present invention. The receiver 50 includes a low noise amplifier (LNA) 44, a mixer 41, a sampling-and-filtering device 42, an ADC 43, a local oscillator 45, and a clock signal generator 46. The local oscillator 45 is coupled to the mixer 41, the mixer 41 is coupled to the LNA 44, and the sampling-and-filtering device 42 is coupled to the ADC 43 and the clock signal generator 46.

The functions of the mixer 41 and the sampling-and-filtering device 42 are described above and will not be described herein again. The LNA 44 receives a radio frequency signal RF_sig′ from a transmission channel and amplifies the radio frequency signal RF_sig′ to generate an amplified radio frequency signal RF_sig. The local oscillator 45 generates a reference signal REF_sig, and as described above, the frequency fₛ of the reference signal and the frequency f_{c} of the radio frequency signal RF_sig are in a relationship of fₛ=(f_{c}±f_{IF})/n, where n is a positive integer. The clock signal generator 46 provides a clock signal CLK_{REF} to the sampling-and-filtering device 42, and the ADC 43 converts the second signal DT into a digital signal BB_sig. However, FIG. 9B illustrates an embodiment of the receiver of the present invention, but does not intend to limit the scope of the present invention. When the power attenuation of the transmission channel is not large, the LNA 44 may be removed or replaced by a general amplifier. Further, for some particular requirements, an analog signal processor may be added between the ADC 43 and the sampling-and-filtering device 42, so as to perform an analog signal processing on the second signal DT.

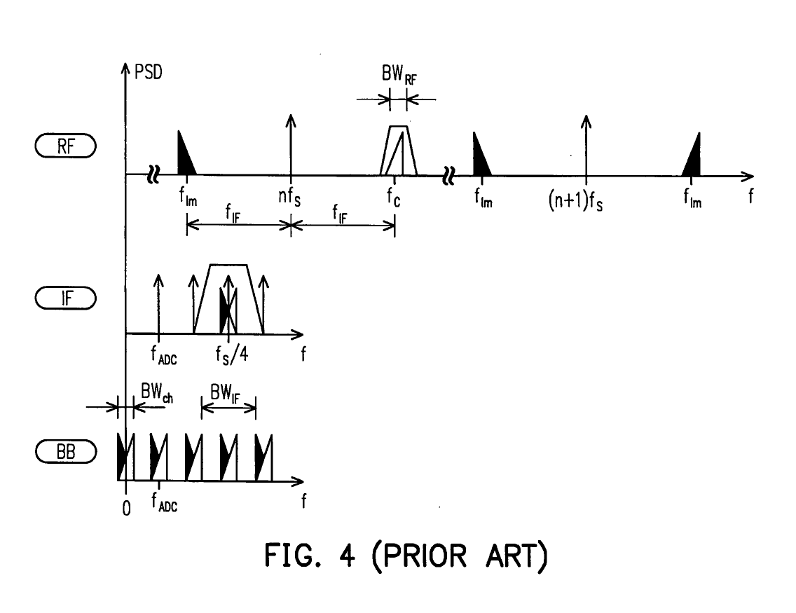

Herein, it is assumed that the first signal CT is the IF signal, and the second signal DT is the baseband signal. However, the assumption is only used to illustrate but not to limit the scope of the present invention. Since the mixer 41 does not perform sampling, the folding noises in a RF segment in FIG. 4 will not be folded into the first signal CT. Referring to FIG. 9C, a schematic frequency spectrum graph of a receiver 50 in each frequency operation segment is shown. As shown in FIG. 9C, the folding noises folded into the first signal CT are less than those in FIG. 4, and the down-conversion of the radio frequency signal into the first signal CT is merely affected by the folding of a noise at an image frequency. Thus, the noises folded during the down-conversion from the first signal CT into the second signal DT is greatly reduced at last. Therefore, the influence of the folding noises is moderated, thus improving the performance of the receiver 50.

Furthermore, in order to improve the performance of the receiver, the image frequencies in the RF operation segment in FIG. 9C can be removed. The architecture of the receiver of the embodiment of the present invention may be used together with a technique of image rejection to eliminate the influence of the noises of the image frequency. The technique of image rejection can be Weaver image rejection, Hartley image rejection, or other relevant techniques capable of reducing the influence of the signal at the image frequency. FIG. 9C is an ideal schematic frequency spectrum, and although the non-linear effects of elements exist in fact, the performance of the embodiment will not be influenced, and the detailed circuit simulation results will be introduced hereinafter.

The sampling-and-filtering device 42 may be implemented according to the patent set forth by Texas Precision Instruments and the papers set forth by Jakonis et al. The sampling-and-filtering device 42 includes a control signal generating unit and a charge-domain filter. The control signal generating unit generates a plurality of control signals according to a reference signal CLK_{REF}. The charge filter is constituted by a plurality of transistors and a plurality of capacitors. The plurality of transistors are controlled by the plurality of control signals. The ON or OFF of the transistors are controlled by the plurality of control signals to charge or discharge the plurality of capacitors, thereby realizing the functions of sampling, filtering, and down-conversion.

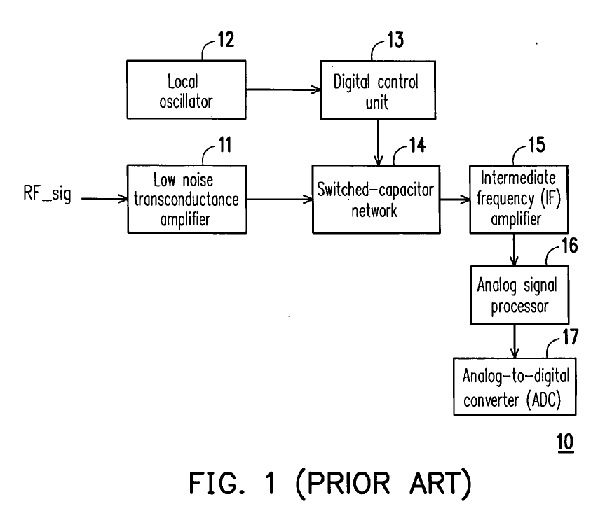

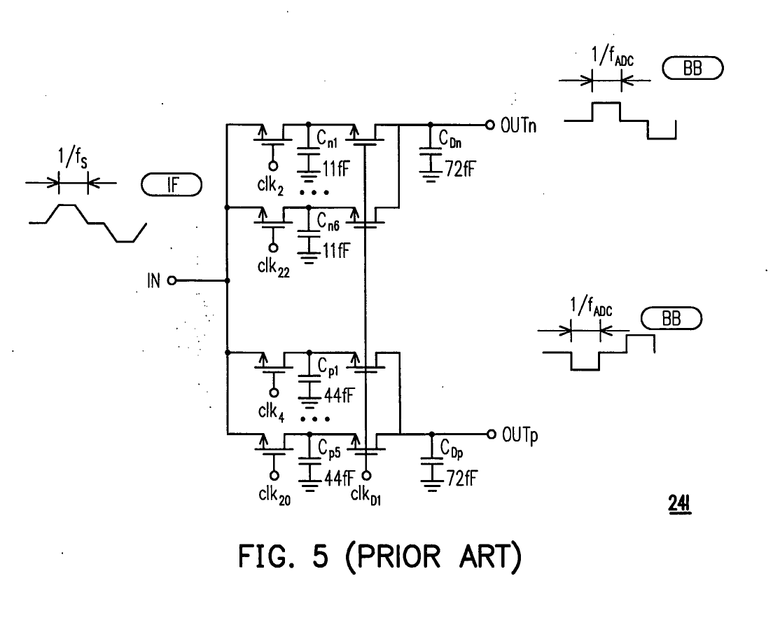

The control signal generating unit and the charge filter may be implemented by the digital control unit 13 and the switched-capacitor network 14 in FIG. 1, except that the reference signal input into the digital control unit 13 is the CLK_{REF}. Further, the charge filter may be implemented by the sub-circuit of the filtering-and-down-conversion devices 24I, 24Q in FIG. 5, as long as the corresponding control signal generating unit is designed according to FIG. 5.

The local oscillator 45 and the clock signal generator 46 in FIG. 9B can be integrated with a conversion circuit therebetween. The frequencies may be different or the same. In brief, the implementation of the local oscillator 45 and the clock signal generator 46 is not intended to limit the present invention. Further, a filter can be added before or after the mixer 41 to improve the performance of the receiver 50. In brief, the receiver 50 is merely an embodiment, but is not intended to limit the present invention.

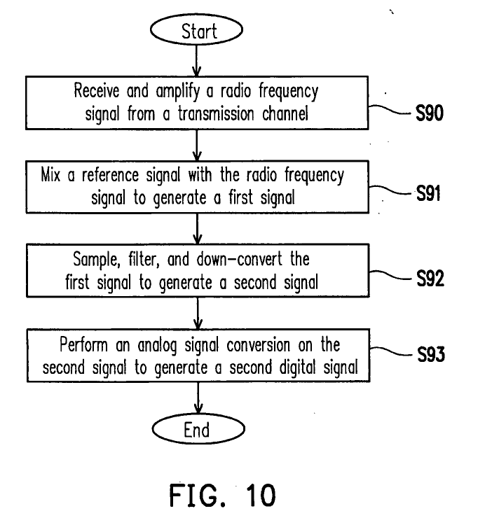

Next, referring to FIG. 10, a flow chart of a method of discrete-time filtering and down-conversion according to an embodiment of the present invention is shown. The method is applicable in a wireless radio frequency receiver. First, in Step S90, a radio frequency signal is received from a transmission channel and amplified. Next, in Step S91, a reference signal and the radio frequency signal are mixed to generate a first signal. The first signal is a continuous-time signal. And then, the first signal is sampled, filtered, and down-converted to generate a second signal. Finally, an analog signal conversion is performed on the second signal to generate a second digital signal.

As described above, when the power attenuation of the transmission channel is not large, Step S90 can be removed. Further, for some particular requirements, a step of analog signal processing on the second signal may be added between Steps S92 and S93. In a word, FIG. 10 is only an embodiment of a method of discrete-time filtering and down-conversion of the present invention, but not intended to limit the present invention.

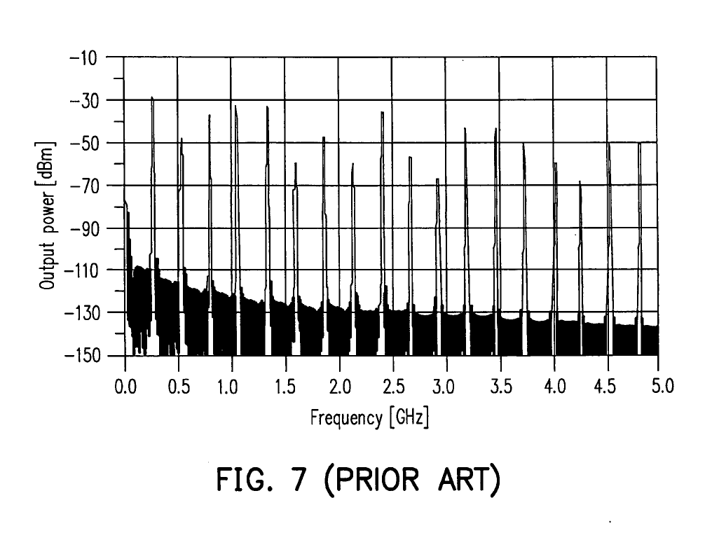

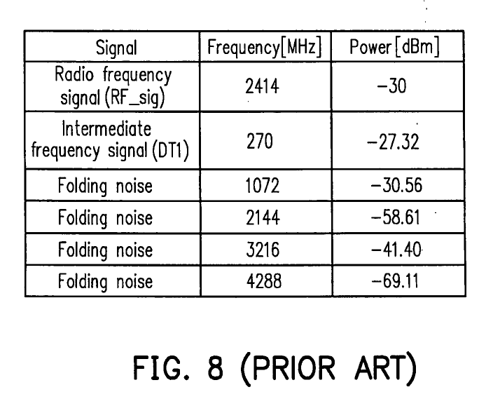

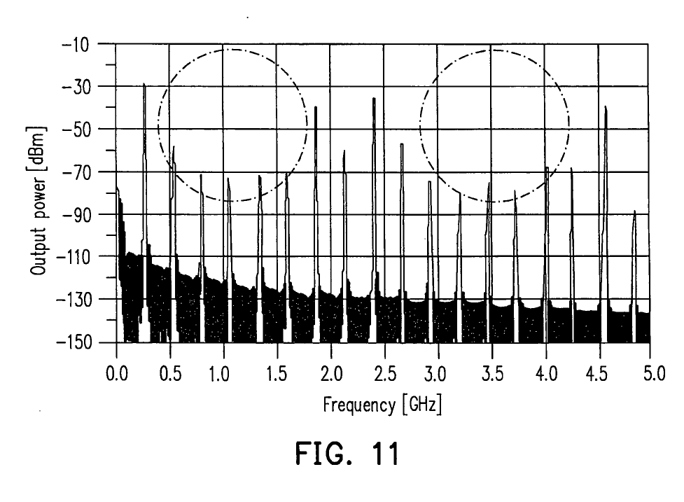

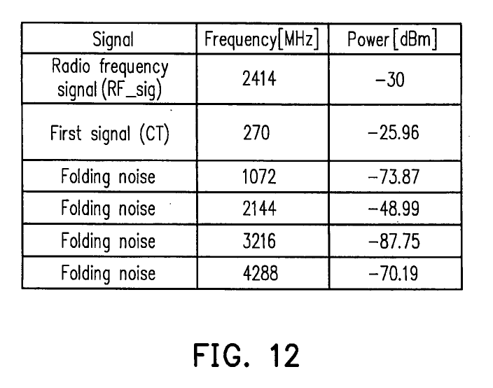

Finally, referring to FIGS. 11 and 12, FIG. 11 is a power-frequency spectrum graph of the first signal CT in FIG. 9A, and FIG. 12 is a frequency-power correspondence table of the first signal CT in FIG. 11. FIGS. 11 and 12 are simulated with the circuit of actual elements. Thus, except the down-converted first signal (270 MHz), the signals of the rest frequencies are the noises caused by the non-ideal characteristics of the elements. However, the effect proposed in the embodiment can also be achieved. As shown in FIGS. 11 and 12, the receiver 40 of the embodiment of the present invention can moderate the folding noises at certain frequencies, thus significantly reducing the power value of the folding noises at certain frequencies of the generated first signal CT (the parts circled by dotted lines in FIG. 11), thereby reducing folding noise folded into the second signal after the first signal passing through the sampling-and-filtering device 42. On the other hand, only the image signals of the input radio frequency signal RF_sig (f_{c}−2f_{IF}, if fc≧nfs or f_{c}+2f_{IF}, if fc≦nfs) of the mixer 41 are folded into the CT. In FIGS. 11 and 12, the frequency of the input radio frequency signal RF_sig is 2414 MHz, the sampling frequency fₛ is 1072 MHz, and the frequency of the first signal CT is 270 MHz. Finally, referring to FIGS. 11, 12 and FIGS. 7, 8, it can be seen that the receiver 40 of the embodiment of the present invention can greatly reduce the power of the folding noises at 1072 MHz, 3216 MHz, 1072 MHz±270 MHz, and 3216 MHz±270 MHz, so as to decrease the power after passing through the sampling-and-filtering device 42 and folded into the second signal DT. Therefore, the receiver 40 has a better performance than the conventional receiver. Further, in this embodiment, f_{IF}=(fₛ/4)+f_{delta}, f_{delta}=2 MHz, which is designed to split the first signal CT to the signals of channel I and channel Q, but not intended to limit the present invention.

In view of the above, the receiver of the embodiment of the present invention adopts a mixer directly mixes and down-converts the radio frequency signal, and then samples, filters, and down-converts the first signal, thus significantly reducing the power of the folding noises at certain frequencies, and thereby having a performance better than the conventional receiver. Furthermore, the frequency of the reference signal for mixing and the frequency of the first radio frequency signal are in a relationship of fₛ=(f_{c}±f_{IF})/n. When n is increased, the power consumed by the receiver is decreased correspondingly. Further, since the folding noises are reduced, the linearity of the receiver is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A receiver with discrete-time filtering and down-conversion, comprising:
a mixer, for receiving a first radio frequency signal and mixing a reference signal with the first radio frequency signal to generate a first signal, wherein the first signal is a continuous-time signal; and
a sampling-and-filtering device, coupled to the mixer, for sampling, filtering, and down-conversion the first signal according to a clock signal to generate a second signal.

2. The receiver with discrete-time filtering and down-conversion according to claim 1, further comprising:
a low noise amplifier (LNA), coupled to the mixer, for receiving a second radio frequency signal from a transmission channel and amplifying the second radio frequency signal to generate the first radio frequency signal; and
an analog-to-digital converter (ADC), coupled to the sampling-and-filtering device, for converting the second signal into a digital signal.

3. The receiver with discrete-time filtering and down-conversion function according to claim 1, further comprising:
a local oscillator, for generating the reference signal; and
a clock signal generator, for generating the clock signal.

4. The receiver with discrete-time filtering and down-conversion according to claim 1, wherein a frequency fₛ of the reference signal and a frequency f_{c} of the first radio frequency signal are in a relationship of fₛ=(f_{c}±f_{IF})/n, where n is a positive integer, and f_{IF} is a frequency of the first signal.

5. The receiver with discrete-time filtering and down-conversion according to claim 1, wherein the second signal is a discrete-time signal.

6. The receiver with discrete-time filtering and down-conversion according to claim 1, wherein the sampling-and-filtering device comprises:
a charge-domain filter, constituted by a plurality of transistors and a plurality of capacitors, wherein the capacitors are charged or discharged by controlling ON or OFF of the transistors through a plurality of control signals, so as to achieve functions of sampling, filtering, and down-conversion; and
a control signal generating unit, for generating the control signals according to the clock signal.

7. The receiver with discrete-time filtering and down-conversion according to claim 1, further comprising:
a filter, coupled to the mixer, for receiving a second radio frequency signal from a transmission channel and filtering the second radio frequency signal to generate the first radio frequency signal.

8. The receiver with discrete-time filtering and down-conversion according to claim 1, wherein the first signal is an intermediate frequency (IF) signal or a first baseband signal, and the second signal is a second baseband signal.

9. A method of discrete-time filtering and down-conversion, comprising:
receiving a first radio frequency signal and mixing a reference signal with the first radio frequency signal to generate a first signal, wherein the first signal is a continuous-time signal; and
sampling, filtering, and down-converting the first signal according to a clock signal to generate a second signal.

10. The method of discrete-time filtering and down-conversion according to claim 9, further comprising:
receiving a second radio frequency signal from a transmission channel, and amplifying the second radio frequency signal to generate the first radio frequency signal; and
converting the second signal into a digital signal.

11. The method of discrete-time filtering and down-conversion according to claim 9, wherein a frequency fₛ of the reference signal and a frequency f_{c} of the first radio frequency signal are in a relationship of fₛ=(f_{c}±f_{IF})/n, where n is a positive integer, and f_{IF} is a frequency of the first signal.

12. The method of discrete-time filtering and down-conversion according to claim 9, wherein the second signal is a discrete-time signal.

13. The method of discrete-time filtering and down-conversion according to claim 9, wherein the step of generating the second signal comprises:
providing a charge-domain filter constituted by a plurality of transistors and a plurality of capacitors, and charging or discharging the capacitors by controlling ON or OFF of the transistors of the charge-domain filter through a plurality of control signals, so as to achieve functions of sampling, filtering, and down-conversion, wherein the control signals are generated according to the clock signal.

14. The method of discrete-time filtering and down-conversion according to claim 9, further comprising:
receiving a second radio frequency signal from a transmission channel, and filtering the second radio frequency signal to generate the first radio frequency signal.

15. The method of discrete-time filtering and down-conversion according to claim 9, wherein the first signal is an intermediate frequency (IF) signal or a first baseband signal, and the second signal is a second baseband signal.
